(19) United States
(12) Patent Application Publication
(10) Pub. No.: US 2011/0153677 A1
(43) Pub. Date: Jun. 23, 2011

(54) APPARATUS AND METHOD FOR MANAGING INDEX INFORMATION OF HIGH-DIMENSIONAL DATA

(75) Inventors: Hyun-Hwa CHOI, Daejeon (KR); Byoung-Seob Kim, Daejeon (KR); Mi-Young Lee, Daejeon (KR)

(73) Assignee: Electronics and Telecommunications Research Institute, Daejeon (KR)

(21) Appl. No.: 12/964,939

(22) Filed: Dec. 10, 2010

(30) Foreign Application Priority Data
Dec. 18, 2009 (KR) 10-2009-0127077
Jun. 7, 2010 (KR) 10-2010-0053406

(51) Int. Cl. G06F 17/30

(52) U.S. Cl. 707/802; 707/E17.057

(57) ABSTRACT

Disclosed herein are an apparatus and method for managing the index information of high-dimensional data. The apparatus for managing the index information of high-dimensional data includes a plurality of data service devices and a control unit. Each of the plurality of data service devices is configured such that user data and index information used to search the user data are allocated thereto. The control unit is configured to extract high-dimensional index data from a large amount of input data and to allocate the extracted index data to the plurality of data service devices by mapping the extracted index data to the plurality of data service devices as the index information.

### CROSS REFERENCE TO RELATED APPLICATIONS

This application claims the benefit of Korean Patent Application No. 10-2009-0127077 filed on Dec. 18, 2009 and Korean Patent Application No. 10-2010-0053406 filed on Jun. 7, 2010, which are hereby incorporated by reference in their entirety into this application.

### BACKGROUND OF THE INVENTION

1. Technical Field

The present invention relates generally to distributed data management technology, and, more particularly, to an apparatus for managing the index information of large amounts of high-dimensional data and a method of managing index information using the apparatus.

2. Description of the Related Art

Recently, as the paradigm of Internet service has shifted from a provider-oriented service to a user-oriented service with the advent of the web 2.0, the market of providing Internet services, such as User Created Content (UCC) and personal service, are rapidly expanding.

Accordingly, a distributed data management system capable of supporting services related to large amounts of data in such a way as to acquire computing power and disk space by combining low-cost computing nodes on a large scale has been introduced. Such a distributed data management system is characterized in that it can manage large amounts of data using distributed storage and management of the data, provide the availability of data service in the event of a node failure, and provide data stability by offering data recovery.

Meanwhile, as the portion occupied by image and moving image services is increasing amongst Internet services, the necessity of content-based searches which are used to search for similar images or moving images based on images or moving images possessed by users is increasing. The content-based search refers to a technique of analyzing images or moving images, converting them into high-dimensional feature vector data, constructing indices thereof, and searching for the most similar images or moving images by comparing similarities between pieces of high-dimensional data.

However, as the amounts of high-dimensional data are increasing due to the activation of the Internet service, a method of managing large amounts of high-dimensional data which cannot be stored in a single computing node is required.

### SUMMARY OF THE INVENTION

Accordingly, the present invention has been made keeping in mind the above problems occurring in the prior art, and an object of the present invention is to provide an apparatus for managing the index information of a large amount of high-dimensional data.

Another object of the present invention is to provide a method of managing high-dimensional index information using the apparatus for managing index information.

In order to accomplish the above objects, the present invention provides an apparatus of managing the index information of high-dimensional data, including a plurality of data service devices each configured such that user data and index information used to search the user data are allocated thereto; and a control unit configured to extract high-dimensional index data from a large amount of input data and to allocate the extracted index data to the plurality of data service devices by mapping the extracted index data to the plurality of data service devices as the index information.

Additionally, in order to accomplish the above objects, the present invention provides a method of managing the index information of high-dimensional data, including extracting high-dimensional index data by sampling a large amount of data, and creating index distribution information from the extracted high-dimensional index data; constructing an index distribution structure having a tree structure in one of a plurality of data service devices based on the index distribution information; and allocating the one data service device to a leaf node of the index distribution structure based on the index distribution structure, and allocating the high-dimensional index data to the plurality of data service devices by mapping the high-dimensional index data to the plurality of data service devices as index information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for managing the index information of high-dimensional data according to an embodiment of the present invention;

FIG. 2 is a diagram showing an example of an index information distribution structure which is constructed by the apparatus for managing index information, shown in FIG. 1.

FIG. 3 is a diagram showing the table structure of data managed by the data service device shown in FIG. 1;

FIG. 4 shows an embodiment in which the apparatus for managing index information, shown in FIG. 1, constructs high-dimensional index information services using data service devices; and

FIG. 5 is a flowchart showing the operation of managing the apparatus for managing index information which is performed when a large amount of new data has been added.

### DESCRIPTION OF THE PREFERRED EMBODIMENTS

Reference now should be made to the drawings, in which the same reference numerals are used throughout the different drawings to designate the same or similar components.

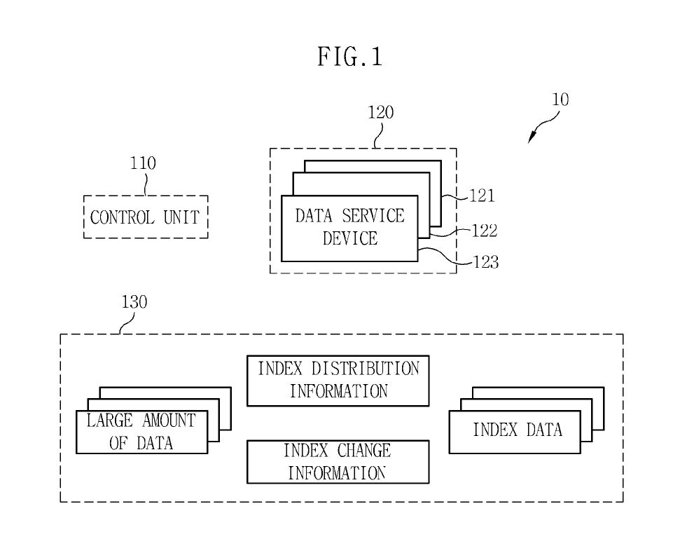

FIG. 1 is a diagram showing the configuration of an apparatus for managing the index information of high-dimensional data according to an embodiment of the present invention.

Referring to FIG. 1, the apparatus 10 for managing index information may include a control unit 110, a data service unit 120, and a storage device 130.

The apparatus 10 for managing index information may be constructed of one or more computing devices, such as servers.

In other words, the control unit 110, data service unit 120 and storage device 130 of the apparatus 10 for managing index information may be constructed of computing devices, such as servers, which can be connected to each other.

Here, the data service unit 120 may include a plurality of data service devices. Each of the plurality of data service devices may be constructed of a computing device, and provide services, such as the insertion, deletion and searching of data.

In this case, the storage device 130 may store or manage a plurality of pieces of data, for example, large amounts of data, high-dimensional index data, index distribution information data, and index change information data in accordance with the service operations performed by the plurality of data service devices.

That is, the apparatus 10 for managing index information according to the present invention may be constructed of a plurality of computing devices, thus forming a database system.

The control unit 110 may allocate part of the index data, stored in the storage device 130, to each of the plurality of data service devices of the data service unit 120 so as to provide services (inserting, deleting or searching data), or withdraw part of the index data from each of the plurality of data service devices so as to stop providing services.

Furthermore, the control unit 110 may support the availability of the data services by allocating and withdrawing data based on monitoring the service operations performed by the plurality of data service devices.

The control unit 110 may extract high-dimensional index data ID using the operation of sampling a large amount of data input by a user.

Furthermore, the control unit 110 may create index distribution information IDI from the extracted high-dimensional index data ID.

In other words, the control unit 110 divides a large feature vector, extracted from the large amount of data input by the user, into a plurality of partitions based on previously constructed index distribution information IDI, thereby constructing distributed high-dimensional indices which are easy to manage.

Furthermore, the control unit 110 may create the index change information ICI of corresponding high-dimensional index data ID based on a large amount of data changed by the user.

The control unit 110 may allocate the created index distribution information IDI, the index data ID divided into a plurality of partitions and the index change information ICI to the plurality of data service devices of the data service unit 120, and manage them based on the storage device 130.

For example, the large amount of data input by the user, the index distribution information IDI, and the index data ID and index change information ICI are stored and managed in the storage device 130 using the plurality of data service devices.

In this case, the storage device 130 may include one or more pieces of storage (not shown) for storing and managing the above-described data.

Meanwhile, one of the plurality of data service devices to which the index distribution information IDI has been allocated by the control unit 110 may construct an index information distribution structure based on the allocated index distribution information IDI.

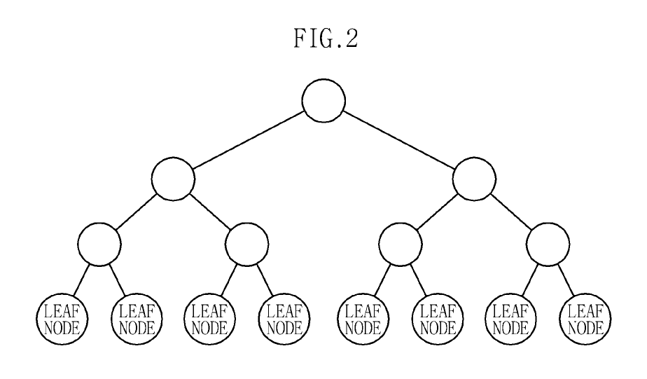

Here, as shown in FIG. 2, the index information distribution structure constructed in the one data service device may have a tree structure including a plurality of leaf nodes, and a plurality of leaf nodes may point to respective data service devices.

The control unit 110 may allocate the index data ID to each of the data service devices mapped to the leaf nodes by mapping the index data ID to each of the data service devices as the index information II based on the index information distribution structure constructed in the one data service device, and cause the data service device to perform services related to the index information II.

Furthermore, the control unit 110 may allocate the index change information ICI to another data service device, and cause the other data service device to which the index change information ICI has been allocated to manage it.

That is, the control unit 110 performs management so that services related to the high-dimensional index data ID extracted from the large amount of data input by the user can be provided using a plurality of data service devices as services related to the index information II, thereby enabling services related to the high-dimensional index data ID to be provided using another data service device even when a problem, such as impossible access, occurs in any one data service device.

In this case, the control unit 110 may allocate the index information II based on the high-dimensional index data ID, which was managed by the data service device having the problem of impossible access, to the other data service device, thereby enabling the continuous services. This can increase the availability of data search for users.

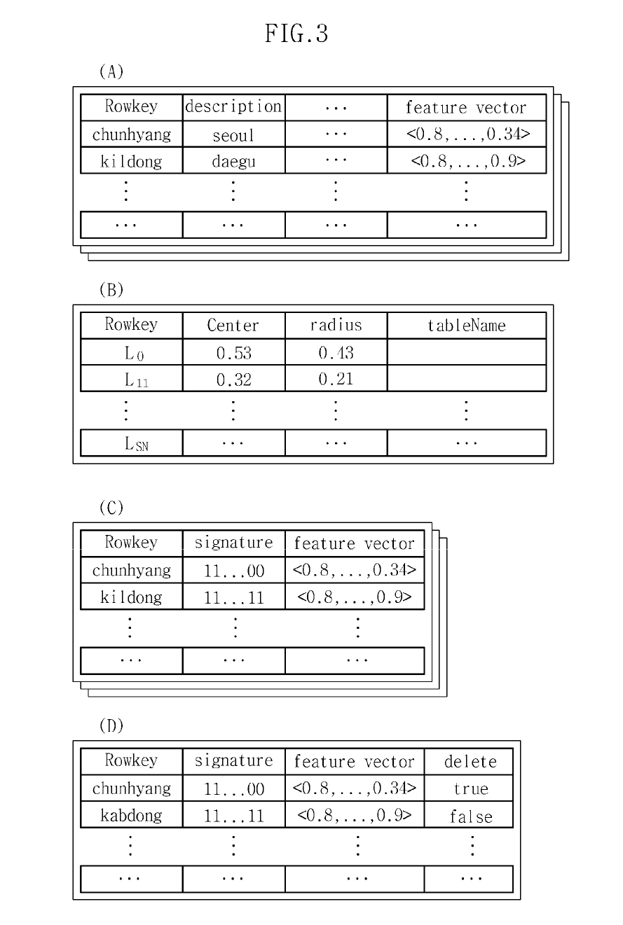

Meanwhile, the index information II managed by the data service device may have a table structure, such as that shown in FIG. 3.

Furthermore, the data service device can perform similarity search using the index information II, that is, content-based search, which will be performed based on user data UD which will be input based on a user query.

FIG. 3 is a diagram showing the table structure of data managed by a data service device shown in FIG. 1.

Referring to FIGS. 1 and 3, each of a large amount of data, index distribution information IDI, high-dimensional index data ID, and index change information ICI may be stored in a table structure.

The large amount of data may be stored in a table structure including row keys, descriptions, and feature vectors, as shown in FIG. 3(A).

The index distribution information IDI may be stored in a table structure in which identifiers for identifying the internal nodes of a tree are used as row keys so as to manage information about the index information distribution structure shown in FIG. 2.

Here, the table structure of the index distribution information IDI may include a center and a radius which indicate a data range defined by the node of each row key, and the name of a table in which corresponding high-dimensional index data ID will be stored.

The high-dimensional index data ID may be stored in a table structure including the row keys, signatures and feature vectors of the above-described table structure in which the large amount of data is stored, as shown in FIG. 3(C). Here, each of the signatures may be a value extracted from a feature vector.

The index change information ICI may be stored in a table structure in which deletion columns indicating changes, for example, the insertion and deletion of index information, are additionally included in the above-described table structure of the high-dimensional index data ID, as shown in FIG. 3(D).

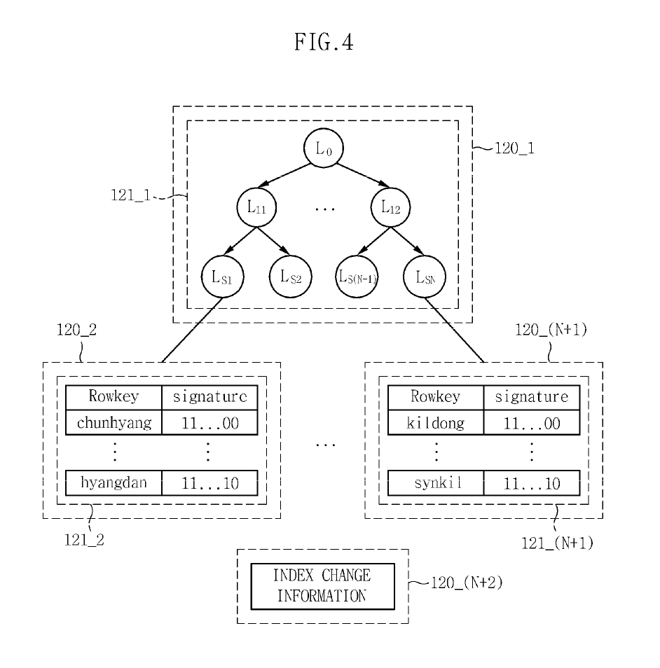

FIG. 4 shows an embodiment in which the apparatus for managing index information shown in FIG. 1 constructs high-dimensional index information services using data service devices.

For ease of description, an example in which the control unit 110 provides services related to M (M is a natural number) pieces of high-dimensional index data ID, extracted from a large amount of data, using (N+2) data service devices as index information II based on an index information distribution structure having a tree structure including N (N is a natural number) leaf nodes, such as that shown in FIG. 2, will now be described.

Referring to FIGS. 1 and 4, the control unit 110 may construct an index information distribution structure 121_1 based on data which is acquired by sampling a large amount of user data.

For example, the control unit 110 may create tables for storing high-dimensional index data ID in data service devices 120_2, . . . , and 120_(N+1) corresponding to respective leaf nodes L_{S1}, L_{S2}, . . . , L_{S(N-1)}, and L_{SN} of the index information distribution structure 121_1. These tables may have row key, signature and feature vector columns, as shown in FIG. 3(c).

The data service devices 120_2, . . . , and 120_(N+1) in which the tables have been created by the control unit 110 may perform services, such as inserting data into the tables or deleting data from the tables. In this case, the control unit 110 may repeat the operation of creating a number of tables equal to the number of leaf nodes of the index information distribution structure 121_1 and allocating the tables.

Here, the creation of the tables of the control unit 110 may include creating files for storing data in the storage devices 130.

Once the tables have been created in and allocated to the data service devices 121_2, . . . , and 121_(N+1), the control unit 110 may create an index distribution information table such as that shown in FIG. 3(B), and allocate this table to one service device 120_1.

Furthermore, information about the index information distribution structure and the names of tables mapped to the leaf nodes may be inserted into the created index distribution information IDI table.

Once the index distribution information IDI has been allocated to the one data service device 120_1, the control unit 110 may control the one data service device 120_1 so that it constructs an index information distribution structure 121_1 in its own memory based on the index distribution information IDI.

Once the index information distribution structure 121_1 has been constructed in the one data service device 120_1, the control unit 110 may extract M pieces of high-dimensional index data ID from the large amount of data input by the user.

Furthermore, the control unit 110 may insert the pieces of extracted high-dimensional index data ID into respective tables of corresponding data service devices 120_2, . . . , and 120_(N+1).

For example, the control unit 110 may request a search from the one data service device 120_1 in which the index information distribution structure 121_1 has been constructed so as to determine the tables of data service devices in which the pieces of extracted high-dimensional index data ID will be stored.

The one data service device 120_1 may return the names of one or more tables in response to a search request from the control unit 110 as the results of the search, and the control unit 110 may request one or more data service devices 120_2, . . . , and 120_(N+1) managing the returned tables to store the high-dimensional index data ID.

The data service devices 120_2, . . . , and 120_(N+1) which were requested to store the high-dimensional index data ID may insert the high-dimensional index data ID into the managed index data tables, and manage it as index information II.

In this case, the data service devices 120_2, . . . , and 120_(N+1) managing the index data tables may store the row keys and signatures of the high-dimensional index data ID in their memory.

The reason for this is that a feature vector of the high-dimensional index data ID is represented by a 4-byte real number per dimension while a signature is represented by n bits (where n is a natural number), for example, 1˜8 bits, so that the signature has a size smaller than that of the feature vector. In other words, the reason for that is to manage the signatures of overall index data, managed by the data service devices, in their memory, thereby improving the performance of similarity searches for content-based searches that are to be performed by the data service devices.

That is, the signatures of index data are managed in the memory of the data service devices, so that when a similarity search is performed, filtering is first performed based on the signatures residing in the memory, and then the data remaining after the filtering is searched based on the feature vectors.

Meanwhile, the data service devices 120_2, . . . , and 120_(N+1) managing the index data may store and manage a number of pieces of high-dimensional index data ID equal to the number determined by the following Equation 1 as index information II:

$$l ≪ \frac{m ( Mbyte )}{k ( byte ) + ( d * b ( bit ) )} \qquad ( 1 )$$

where l is the number of pieces of the index information, m is the size of the memory of a data service device, k is the maximum size of a row key, d is the number of dimensions of a feature vector, and b is the number of bits of a signature per dimension.

Once M pieces of high-dimensional index data ID have been allocated to and stored in the data service devices 120_2, . . . , and 120_(N+1) as the index information II, the control unit 110 may complete the construction of high-dimensional indices which are used to provide the service of performing content-based search on the large amount of data input by the user.

In order to manage the changes made to the indices by the user, for example, changes in the index information II that reflects changes in the data that were made by the user, after constructing the high-dimensional indices, the control unit 110 may create a table such as that shown in FIG. 3(D).

Furthermore, the control unit 110 may allocate the created table to another data service device 120_(N+2), and cause the data service device 120_(N+2) to manage the table.

Another data service device 120_(N+2) managing the index change information ICI may manage the row keys and signatures of high-dimensional index data ID inserted later using its own memory, and manage them so that index change information ICI is referred together when the data service devices 120_2, . . . , and 120_(N+1) perform content-based searches in response to a request from the user.

Meanwhile, the control unit 110 may manage the index change information ICI in such a way as to periodically incorporate index change information ICI into the index information II allocated to the data service device 120_2, . . . , and 120_(N+1) when the index change information ICI exceeds a threshold value.

At this time, there may be a case where the number of pieces of index information II, that is, the number of pieces of high-dimensional index data ID, allocated to one of the plurality of data service devices 120_2, . . . , and 120_(N+1) exceeds the threshold value of each data service device.

Here, the threshold value of the data service device 120_2, . . . , and 120_(N+1) may be calculated using the above-described Equation 1.

In this case, the control unit 110 may request the one data service device 120_1, in which the index information distribution structure 121_1 has been constructed, to divide a corresponding node, that is, a leaf node to which the corresponding data service device has been mapped.

In this case, the control unit 110 may create two more tables for two leaf nodes which will be newly created. The two newly created tables may be allocated to and managed by new data service devices.

The control unit 110 may search for the index information distribution structure 121_1 in which a leaf node division has been completed, store the index information, that is, the high-dimensional index data ID, which was managed by the data service device which has exceeded the threshold value, in a new corresponding data service device based on the results of the search to perform data division.

Once the high-dimensional index information II has been divided, the control unit 110 may stop providing services by withdrawing the high-dimensional index data ID from the data service device which has exceeded the threshold value, and eliminate a corresponding table from the storage device 130 by deleting the table.

Furthermore, the control unit 110 may incorporate one or more changes in the index information distribution structure 121_1 constructed in the one data service device 120_1, one or more deleted table names and/or one or more created new table names into a corresponding table.

Once information related to the division has been incorporated, the control unit 110 may search for index change information ICI not incorporated using the index information distribution structure 121_1, and complete the incorporation of all pieces of index change information ICI by inserting the index information II into one or more data service devices according to the results of the searching. Here, the index change information ICI, the incorporation of which has been completed may be deleted from the index change information table.

Meanwhile, when the control unit 110 incorporates the index change information ICI into the index information II, there may be a case where the number of pieces of index information II allocated to one of the data service devices 120_2, . . . , and 120_(N+1) is less than the threshold value.

In such a case, the control unit 110 may detect a corresponding node from the index information distribution structure 121_1 constructed in the one data service device 120_1, and merge the node with a neighboring node.

The control unit 110 may merge two target leaf nodes of the index information distribution structure 121_1, merge the index information II which was managed by two data service devices mapped to the leaf nodes, and then incorporate information related the merging into the index distribution information.

Furthermore, after the index information has been merged, the control unit 110 may perform and complete the incorporation of not incorporated index change information ICI into the index information.

In order to minimize changes made to the index information distribution structure 121_1 by the incorporation of the index change information ICI, the control unit 110 may first incorporate index change information based on deletion, and then incorporate index change information based on addition.

In this case, merging with a neighboring node is not performed when the index change information based on deletion is incorporated, and only the division of a node is performed when index change information based on addition is incorporated.

Once index change information based on addition has been incorporated, the control unit 110 may determine which data service devices that are managing index information less than the threshold value are to be merged, and then perform the merging.

As described above, in the apparatus 10 for managing index information according to the present invention, when any one data service device stops providing services due to the occurrence of a failure, such as impossible access, during the provision of services related to the high-dimensional index information of a large amount of data using a plurality of data service devices, the control unit 110 allocates the table of index information II, which was managed by the data service device in which the impossible access occurred, to another data service device, so that services can be continuously provided to the user.

Here, the control unit 110 may perform the re-allocation of the index information II by notifying the new data service device of the table name or table storage location of the index information II which was managed by the data service device in which impossible access occurred.

Furthermore, the data service device to which the table name or table storage location has been allocated by the control unit 110 may access the high-dimensional index data ID of the corresponding table in the storage device 130, and perform services, such as inserting or deleting data.

In this procedure, the data service device may perform a recovery process on the high-dimensional index data ID, as on the large amount of data input by the user.

Using this procedure, the present invention can provide the consistency and stability of the index information II which are being managed by the data service devices, and guarantee availability.

Furthermore, since the apparatus 10 for managing index information is configured such that an index information distribution structure and signatures are allocated to and stored in the memory of the data service devices, the performance of search which is to be performed on content-based search does not decrease.

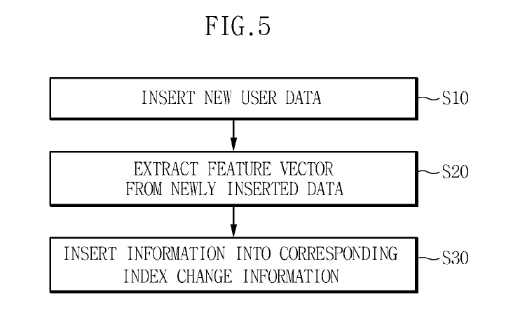

FIG. 5 is a flowchart showing the operation of managing the apparatus for managing index information which is performed when a large amount of new data has been added.

Referring to FIGS. 1, 4 and 5, when a user inserts a new large amount of data, the control unit 110 may request one of a plurality of data service devices, managing a corresponding table, to insert the data at step S10.

Furthermore, the control unit 110 may extract feature vectors and signatures from the new data at step S20.

The control unit 110 may request the data service device 120_(N+2), which is managing the index change information ICI of the high-dimensional index information, to delete (insert) information related to the row keys, feature vectors, signatures of the new data and whether to delete corresponding data at step S30.

The apparatus and method for managing the index information of high-dimensional data according to the present invention are capable of, while managing the index information of a large amount of high-dimensional data, such as that of a moving image or an image, using a distributed data management method, providing the stability and high availability of the index information and also guaranteeing the performance of searching the high-dimensional data.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus of managing index information of high-dimensional data, comprising:
a plurality of data service devices each configured such that user data and index information used to search the user data are allocated thereto; and
a control unit configured to extract high-dimensional index data from a large amount of input data and to allocate the extracted index data to the plurality of data service devices by mapping the extracted index data to the plurality of data service devices as the index information.

2. The apparatus as set forth in claim 1, wherein the control unit creates index distribution information from the extracted high-dimensional index data and constructs an index distribution structure having a tree structure in one data service device among the plurality of data service devices based on the index distribution information.

3. The apparatus as set forth in claim 2, wherein the control unit allocates the index information to the one data service device by mapping the one data service device to each of leaf nodes of the index distribution structure.

4. The apparatus as set forth in claim 2, wherein the control unit creates index change information from the large amount of data, and allocates the index change information to another of the plurality of data service devices by mapping the index change information to the data service device.

5. The apparatus as set forth in claim 4, wherein the control unit divides or merges the high-dimensional index data based on the index change information.

6. The apparatus as set forth in claim 1, wherein the index information comprises row keys, signatures and feature vectors, and is allocated to each of the plurality of data service devices in a table structure.

7. The apparatus as set forth in claim 6, wherein each of the plurality of data service devices stores the row keys and the signatures in its memory.

8. The apparatus as set forth in claim 1, wherein the control unit allocates the high-dimensional index data to each of the plurality of data service devices based on the following Equation;
$$l ≪ \frac{m ( Mbyte )}{k ( byte ) + ( d * b ( bit ) )}$$
where l is a number of pieces of the index information, m is a size of the memory of the data service device, k is a maximum size of a row key, d is a number of dimensions of a feature vector, and b is a number of bits of a signature per dimension.

9. A method of managing index information of high-dimensional data, comprising:
extracting high-dimensional index data by sampling a large amount of data, and creating index distribution information from the extracted high-dimensional index data;
constructing an index distribution structure having a tree structure in one of a plurality of data service devices based on the index distribution information; and
allocating the one data service device to a leaf node of the index distribution structure based on the index distribution structure, and allocating the high-dimensional index data to the plurality of data service devices by mapping the high-dimensional index data to the plurality of data service devices as index information.

10. The method as set forth in claim 9, wherein:
the index information comprises row keys, signatures, and feature vectors; and
the allocating the high-dimensional index data by mapping the high-dimensional index data to the plurality of data service devices as index information comprises storing the index information in each of the plurality of data service device in a table structure with the row keys and the signatures stored in memory of the data service device.

11. The method as set forth in claim 9, wherein the allocating the high-dimensional index data by mapping the high-dimensional index data to the plurality of data service devices as index information comprises allocating the high-dimensional index data to each of the plurality of data service devices as the index information based on the following Equation;
$$l ≪ \frac{m ( Mbyte )}{k ( byte ) + ( d * b ( bit ) )}$$
where l is a number of pieces of the index information, m is a size of the memory of the data service device, k is a maximum size of a row key, d is a number of dimensions of a feature vector, and b is a number of bits of a signature per dimension.

12. The method as set forth in claim 9, further comprising creating index change information from the large amount of data, and allocating the index change information to another of the a plurality of data service devices by mapping the index change information to the data service device.

13. The method as set forth in claim 12, further comprising dividing or merging the high-dimensional index data based on the index change information.

14. The method as set forth in claim 12, wherein the index change information is incorporated into the index information allocated to the plurality of data service devices periodically or at a specific time.

15. The method as set forth in claim 9, further comprising, when a failure has occurred in a specific data service device during provision of services related to the index information using the plurality of data service devices, allocating the index information, which was managed by the specific data service device, to another data service device again and continuously providing services related to the index information.

16. The method as set forth in claim 15, wherein the allocating the index information to another data service device again and continuously providing services comprises allocating the index information by notifying the other data service device of a table name or table storage location of the index information.
